(19) United States
(12) Patent Application Publication
(10) Pub. No.: US 2005/0183582 A1
(43) Pub. Date: Aug. 25, 2005

(54) Controls for magnetic stirrer and/or hot plate

(76) Inventors: Curt McFadden, Dubuque, IA (US); Kenneth David Hermsen, Dubuque, IA (US); Roger W. Earle, Dubuque, IA (US); James R. Edwards, Dubuque, IA (US); Kerry W. Leppert, Dubuque, IA (US); Eric Jackson, Dubuque, IA (US); Eric Garz, Platteville, WI (US); Mark Lockwood, Dubuque, IA (US)

Correspondence Address: WOOD, HERRON & EVANS, LLP, 2700 CAREW TOWER, 441 VINE STREET, CINCINNATI, OH, 45202, US

(21) Appl. No.: 11/064,778

(22) Filed: Feb. 24, 2005

Related U.S. Application Data
(63) Continuation-in-part of application No. 10/922,438, filed on Aug. 20, 2004.
(60) Provisional application No. 60/496,744, filed on Aug. 21, 2003.
(60) Provisional application No. 60/547,377, filed on Feb. 24, 2004.

(51) Int. Cl. A47J 9/00

(52) U.S. Cl. 99/348

(57) ABSTRACT

Controls for stirrers, hot plates and stirring hot plates provide respective user interfaces having a single control knob that is used to provide a plurality of setpoints. The control permits a user to pause a stirring operation of stirrers and stirring hot plates, unload a vessel, load a new vessel, and restart the stirring without having to re-enter a speed setpoint. Also, current operational parameters may be stored as preset setpoints. The control further permits a user to program a calibration temperature that is similar to the temperatures expected to be encountered during operation.

### RELATED APPLICATIONS

The present application is a continuation-in-part of U.S. patent application Ser. No. 10/922,438, entitled STIRRING HOT PLATE, filed on Aug. 21, 2004, which claims the benefit of U.S. Provisional Patent Application Ser. No. 60/496,744 entitled STIRRING HOT PLATE, filed on Aug. 21, 2003 and the benefit of Ser. No. 60/547,377 entitled STIRRING HOT PLATE, filed Feb. 24, 2004, the disclosures of which are herein incorporated by reference in their entirety.

### FIELD OF THE INVENTION

This invention relates generally to laboratory equipment and more particularly, to controls for, and the operation of, magnetic stirrers, hot plates and stirring hot plates.

### BACKGROUND OF THE INVENTION

Magnetic stirrers and stirring hot plates are widely used in the chemical, medical, food and agricultural technology industries. With either device, a stirring operation is obtained by using a stationary base with a platform or plate on which a fluid vessel rests. A magnetic stir bar is placed in liquid in the vessel, and the magnetic stir bar is coupled by a magnetic field to magnets rotated by a motor beneath the plate. The rotating magnets provide rotating magnetic fields that couple to the magnetic stir bar, thereby causing a corresponding rotation of the magnetic stir bar in the liquid. In addition to the above stirring components, a stirring hot plate includes a heating element, so that while the fluid is being stirred, it can be heated to a desired temperature.

Often, a user desires to execute successive identical stirring processes. With known magnetic stirrers and stirring hot plates, this can be accomplished in two ways. First, after one stirring process is completed, the power switch is turned off; the fluid vessels exchanged and power switch turned on again. However, upon removing power, the stirring speed setpoint is lost and has to be reprogrammed after the power is turned back on. With a second method, when one stirring process is done, the user simply lifts the vessel off of the stirrer without stopping the stirring motor, thereby abruptly decoupling the magnetic stir bar from the rotating magnets. That abrupt decoupling results in the magnetic stir bar clanging around in the vessel. When another fluid vessel is placed on the stirrer, with higher stirring speeds, the magnetic stir bar may not automatically couple; and the stirring speed must be reduced until a magnetic coupling is achieved. Such a process is time consuming and frustrating to a user. Thus, there is a need for a stirrer operation that permits one vessel to be quickly removed from, and another vessel placed on, the stirrer plate with a minimum of user intervention and stirring bar motion.

As stirrers, hot plates and stirring hot plates become more versatile with additional programmable features, the control panel or user interface required for programming and operation also becomes more complicated. Some such devices use LED screens or other displays in combination with a keypad for entering programming functions; however, while displays and keypads are very versatile, they do have some disadvantages. For example, the entry of data by a user requires navigating through a series of menu screens which can be time consuming and subject to error. In addition, stirring hot plates are often located on a bench; and the indicia displayed on a screen is not always readily readable by a user. While more traditional control knobs and switches are easy and quick to use, the addition of new features requires more control knobs and switches; and the physical size of a control panel can become too large. Therefore, there is a need for a control panel or user interface for a stirrer, hot plate and/or stirring hot plate that is fully featured and can be quickly and easily used by a user.

Hot plates and stirring hot plates typically use a temperature control feedback loop that monitors the temperature of the hot plate platform, compares it with a desired temperature setpoint, and controls the heating element accordingly. Commercially available temperature sensors that are used to detect hot plate temperature provide an output signal that changes with temperature, but such changes do not represent an accurate temperature measurement. Further, the temperature feedback signal is also affected by mechanical and thermodynamic properties of the hot plate, electrical connections, wiring, etc. Therefore, in order for a temperature control to correlate a temperature feedback signal with an absolute temperature, the control's temperature measuring system must be calibrated. Known hot plates and stirring hot plates are calibrated as part of the manufacturing process prior to sales of the units. Many temperature controls use a closed loop control that has a limited temperature range within which the temperature can be satisfactorily controlled with respect to a factory set calibration temperature. To overcome that limitation, known stirring hot plate controls allow a user to select one of several factory set calibration temperatures. The use of several factory preset calibration temperatures is one approach to addressing the temperature control limitations, but it does have a major disadvantage. It does not allow the user to select a calibration temperature that is specific to a user's particular application. If the user requires a temperature setpoint that is between the factory preset calibration temperatures, the control may not be able to satisfactorily control the temperature of the hot plate to a desired temperature setpoint. Therefore, there is a need for a temperature control for hot plates and stirring hot plates that permits a user to select one or more calibration temperatures that are similar to temperature setpoints at which the hot plate is expected to be operated.

### SUMMARY OF THE INVENTION

The present invention provides a control for a stirrer or a stirring hot plate that allows a user to easily pause or interrupt the stirring action by quickly stopping the spinning action of the stirring bar within the liquid without losing a desired speed setpoint and thereafter, quickly resume the stirring bar rotation at the desired speed setpoint. Thus, upon initiating a pause operation, one vessel can be quickly removed, and another loaded, with a minimum of stirring bar rotation for the pause duration. At the end of the pause operation, the stirring bar operation is quickly brought up to the previous speed setpoint without having to reprogram the stirring speed.

The present invention provides a control panel for a stirrer, hot plate, or a stirring hot plate that more efficiently utilizes control knobs, so that a fully featured but smaller control panel of control knobs and switches is provided. More specifically, a single control knob is used to enter a plurality of setpoint values.

The present invention further provides a control for a hot plate or stirring hot plate that permits a user to select one or more calibration temperatures that are similar to temperatures required by different user applications. Thus, the user is not limited to a limited number of factory set calibration temperatures; and the control is better able to control the hot plate temperature to desired hot plate temperature setpoints.

According to the principles of the present invention and in accordance with the described embodiments, the invention provides a magnetic stirrer for stirring a liquid in a vessel. The stirrer has a plate that supports a vessel containing a liquid to be stirred, and a magnetic stir bar is placed in the liquid in the vessel. A motor is mounted below the plate and is operative to provide a magnetic field coupling with the stir bar, thereby rotating the stir bar and stirring the liquid in the vessel. A programmable control is connected to the motor, and the control has a memory for storing a speed setpoint determined by a user. The control is operable to rotate the stirring bar at a speed substantially equal to the speed setpoint. The control further has a first input device operable to cause the control to initiate a pause operation by stopping the motor and hence, a stirring bar rotation, while maintaining the speed setpoint within the control. In another embodiment of the invention the above structure is applied to a stirring hot plate.

In a further embodiment, the invention provides a magnetic stirrer having a mechanical structure similar to that described above. However, in this embodiment, the programmable control has a memory for storing a plurality of setpoints determined by a user, and one input device operable to provide quantitative values for different ones of a plurality of setpoints, for example, temperature, speed and/or time setpoints. In alternative embodiments, this invention can be applied to hot plates and stirring hot plates.

In a still further embodiment, the invention provides a hot plate for heating a liquid in a vessel, wherein a plate supports a vessel containing a liquid to be heated. A heating element and a temperature sensor are in a heat transfer relationship with the vessel supported on the plate, and a control is connected to the heating element and the temperature sensor. The control has a memory for storing a calibration temperature determined by a user, a temperature measurement system including the temperature sensor, and a first input device. The first input device is operable to provide a calibration temperature and a calibration value, wherein the calibration value is determined from a temperature measurement more accurate than a temperature detected by the temperature sensor. The control is operable to use the calibration value to calibrate the temperature measurement system to the calibration temperature. In another embodiment, this invention is applicable to a stirring hot plate.

These and other objects and advantages of the present invention will become more readily apparent during the following detailed description taken in conjunction with the drawings herein.

### BRIEF DESCRIPTION OF THE DRAWINGS

FIG. 1 depicts a schematic block diagram of an exemplary stirring hot plate in accordance with the principles of the present invention.

FIG. 2 illustrates a full-power alternating-current (AC) waveform.

FIG. 3A illustrates a phase-controlled waveform having substantially a 50% duty-cycle as compared to the waveform of FIG. 2.

FIG. 3B illustrates a rectified waveform having substantially a 50% duty-cycle as compared to the waveform of FIG. 2.

FIG. 4A illustrates one embodiment of an exemplary control panel for a stirring hot plate in accordance with the principles of the present invention.

FIG. 4B illustrates an alternative embodiment of an exemplary control panel for a stirring hot plate in accordance with the principles of the present invention.

FIG. 4C illustrates an embodiment of an exemplary control panel for a stirrer in accordance with the principles of the present invention.

FIG. 4D illustrates an embodiment of an exemplary control panel for a hot plate in accordance with the principles of the present invention.

FIG. 5 depicts a flowchart of an exemplary control algorithm for using a single control knob on the control panel to input a plurality of setpoints.

FIG. 6 depicts a flowchart of an exemplary control algorithm for executing a pause operation of a stirrer or stirring hot plate during its operation.

FIG. 7 depicts a flowchart of an exemplary control algorithm for storing current operating parameters of a stirrer, a hot plate or a stirring hot plate as a preset.

FIG. 8 depicts a flowchart of an exemplary control algorithm for allowing the user to select a calibration temperature for a hot plate or a stirring hot plate.

### DETAILED DESCRIPTION OF THE INVENTION

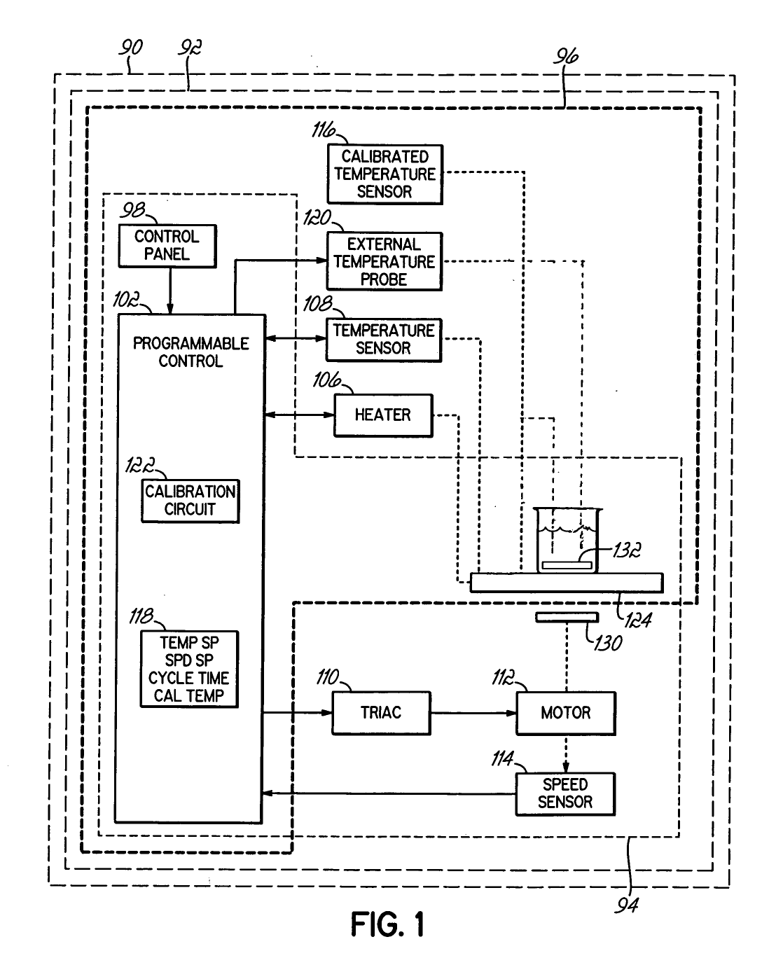

Referring to FIG. 1, the components illustrated therein are exemplary of either a stirrer, hot plate or stirring hot plate; and as used herein, the term “unit” refers to any one of a stirrer, hot plate of stirring hot plate. Thus, a unit 90 includes either a stirring hot plate 92 that utilizes all of the components shown in FIG. 1, a stirrer 94 that utilizes a control 102, a control panel 98, a triac 110, a motor 112 and speed sensor 114 or a hot plate 96 that utilizes the control 102, control panel 98, the heater 106, temperature sensor 108, calibrated temperature sensor 116, external probe 120 and calibration circuit 122. The various inventions described herein relate, as applicable, to the stirrer 94, the hot plate 96 or the stirring hot plate 92.

The control 102 can be implemented using one or more known programmable controls, controllers, microcontrollers, etc. that are capable of managing the operation of the unit 90 according to embedded software routines. One of ordinary skill will appreciate that control 102 can be implemented using a variety of equivalent hardware devices and software applications.

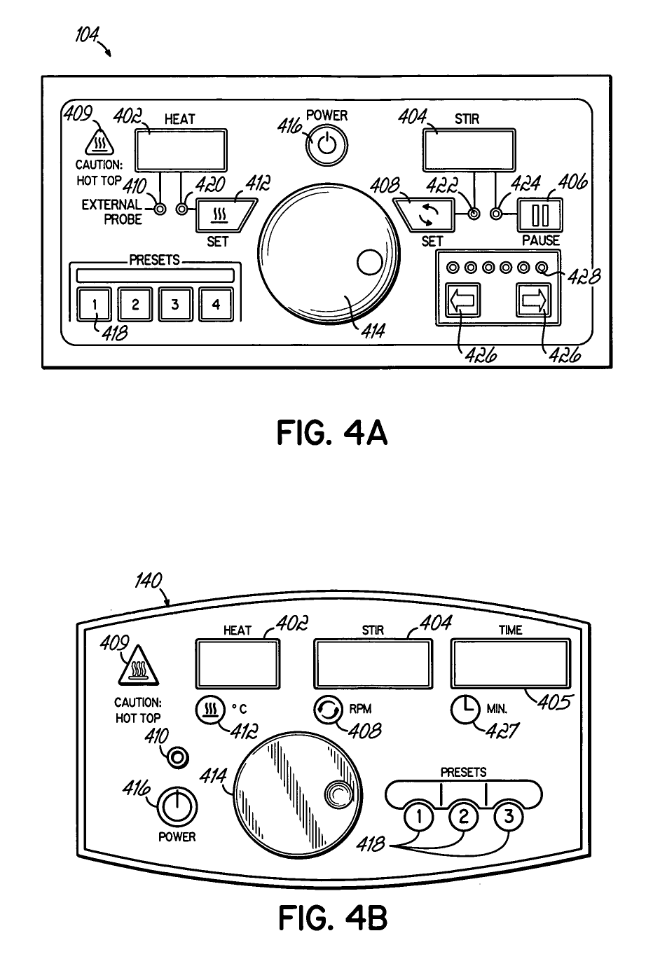

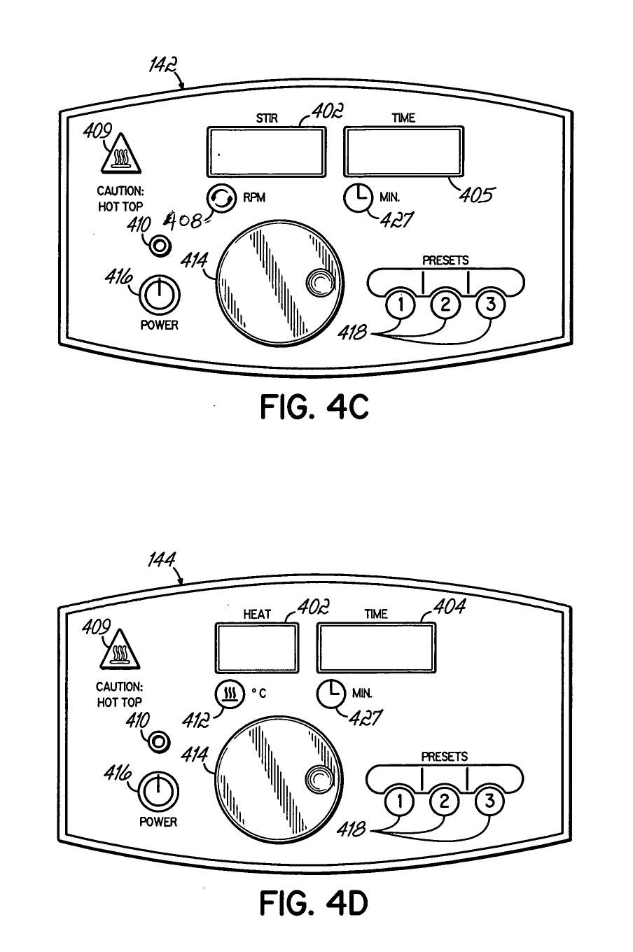

The control panel 98 provides an interface for a user to enter operating parameters and otherwise control the operation of a unit. One example of the control panel 98 is a control panel 104 for a stirring hot plate shown in FIG. 4A. The control panel 104 has an input device 414, for example, a rotating control knob, that permits a user to enter temperature and speed setpoint values at which the stirring hot plate is to be operated. By using the knob 414, desired operating temperature and speed setpoints can be entered and stored in a memory 118 within the control 102.

The control panel 104 also includes output devices, such as LEDs, 420, 422 and 424 and 7-segment displays 402, 404, that provide to a user an indication of how the hot plate is operating. For example, the control panel 104 can display the current temperature of the hot plate or the temperature setpoint within the display 402, the stirrer speed setpoint or current stirrer speed within the display 404, and whether the unit power is on or off. One particularly useful display is an indicator 409 that is illuminated if the hot plate's surface remains over a temperature limit even though the unit power has been turned off. One of ordinary skill will readily appreciate that not all the LEDs in the control panel are required and that other display elements may be added.

In response to a user entering a desired operating temperature as a temperature setpoint via the control panel 104, the control 102 energizes a heater 106 that warms a platform or plate 124 that, in turn, heats a vessel 126 containing a liquid 128. As will be appreciated, a dry bath block can be used instead of the vessel 126 and liquid 128. A temperature sensor 108, for example, an RTD, a thermocouple, etc., senses the hot plate temperature and provides temperature feedback to the control 102. The control 102 utilizes the temperature feedback and the temperature setpoint with a known temperature control algorithm or program, for example, a PID control, to control the operation of the heater 106. In this way, the control 102 is able to maintain the plate 124 at a temperature substantially equal to the temperature setpoint. A calibration circuit 122 calibrates the control's temperature measuring system, so that with the temperature feedback, the control 102 is able to control the heater 106 such that the plate 124 and/or the liquid 128 is maintained at the input temperature setpoint.

The control of the motor 112 for a stirring operation may be accomplished in a number of ways in order to operate the stirring hot plate at the desired speed. The present invention does not require any specific method for controlling the motor 112; however, an exemplary motor control embodiment is described below that provides a number of advantages and benefits.

Typically, the control 102 controls the speed of the motor 112 by switching a triac 110 on and off. One exemplary embodiment of the stirring hot plate uses a triac 110 along with a shaded pole motor 112 to rotate magnets 130 immediately below the plate 124 at a desired speed. The rotating magnets 130 couple with a magnetic stir bar 132 in the vessel 126 on top of the plate 124, so that a liquid 128 is stirred. In some embodiments, unlike the schematic drawing of FIG. 1, the triac 110 may be a part of the control 102.

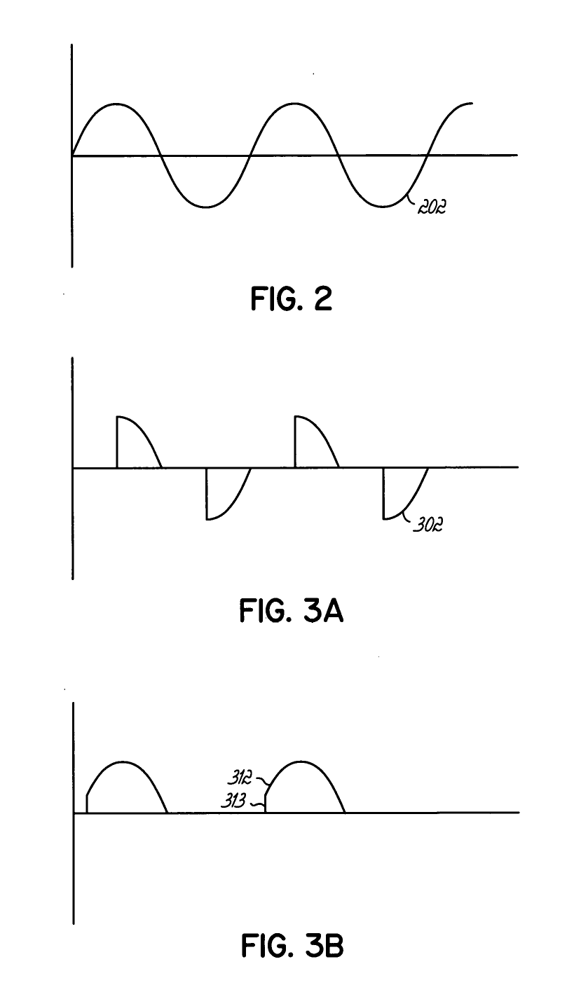

FIG. 2 depicts an AC waveform 202 that could be used to energize the motor 112. However, to obtain accurate and stable control of the motor speed, phase control can be introduced through the use of the triac 110. The triac can be turned on (i.e., allowing current flow) for a portion of the waveform of FIG. 2 and then switched off at a zero crossing. A phase controlled waveform 302 is illustrated in FIG. 3A. In particular, the waveform 302 has a 50% duty cycle.

The power to the motor 112 is a ratio of the area under the waveform 302 versus that of the full AC waveform 202, which in this case is 50%. Speed is not linearly related to the power supplied to the motor so the motor speed resulting from waveform 302 will be less than 50% of that which would result from waveform 202.

Embodiments of the present invention permit the stirrer speed to be adjusted from approximately 50 revolutions per minute (“rpm”) to approximately 1200 rpm. This range of speeds corresponds to a duty cycle range of approximately 25% to approximately 95%. However, one of ordinary skill will appreciate that other duty cycles and speed ranges are contemplated within the scope of the present invention. The specific correlation between duty cycle and speed depends on a number of factors, for example, such as the fluid's viscosity, the temperature of the fluid, the stir bar mass and shape, the flask shape and the material of the flask.

In addition to this usable duty cycle range, the triac 110 and motor 112 can be utilized to quickly brake the rotating magnets 130 and magnetic stir bar 132. With known units, the stirring action is terminated by disconnecting power from the motor 106, which results in the magnets 130 and magnetic stir bar 132 continuing to spin in a deceleration that is determined by the mass of the stir bar 132, the viscosity of the liquid 128 and gravity. Such spinning often continues for much longer than a user desires to wait.

However, with the present invention, the motor 106 can be rapidly braked so as to quickly slow the magnets 130 and the coupled magnetic stir bar 132. When a user turns the stirrer operation off, the control 102 detects this condition and operates the triac accordingly. More particularly, the exemplary waveform 312 of FIG. 3B is a positively rectified waveform has substantially a 50% duty cycle. The exemplary waveform 312 is a positively rectified version of the waveform 202 of FIG. 2; however, a negatively rectified waveform can also be used. Additionally, the waveform 312 is cutoff around region 313 slightly before a zero-crossing. By doing so, the control 102 can ensure that no power of the opposite polarity is inadvertently applied to the motor 106 due to the finite timing constraints of the triac 110 and its associated control circuitry. Allowing anywhere from 70 to 90% of the possible waveform 312 to be applied to the motor 106 before cutting it off is sufficient to prevent unintended application of power to the motor 106. In alternative embodiments of the present invention, no portion of the exemplary waveform 312 is cutoff thereby providing 100% of the positively rectified waveform. In other embodiments, waveforms having less than 70% duty cycle can accomplish the braking action as well. Alternatively, instead of a rectified waveform, a DC waveform may be applied to the motor as well to initiate braking action.

Operating the motor according to the waveform 312 for approximately one to four seconds, such as 1.6 seconds, can quickly stop the motor rotation even from its highest speed setting, such as, for example, 1200 rpm. As a result, a magnetic stir bar can be quickly stopped and a vortex within a stirrer mixture can be quickly collapsed if needed. If desired, a speed sensor 114 can be used to sense the motor's speed and provide it as feedback to the control 102. The motor speed can be used, for example, to determine when braking action can be terminated. For example, when a desired speed is reached, for example, zero rpm, the control 102 ceases applying the braking action.

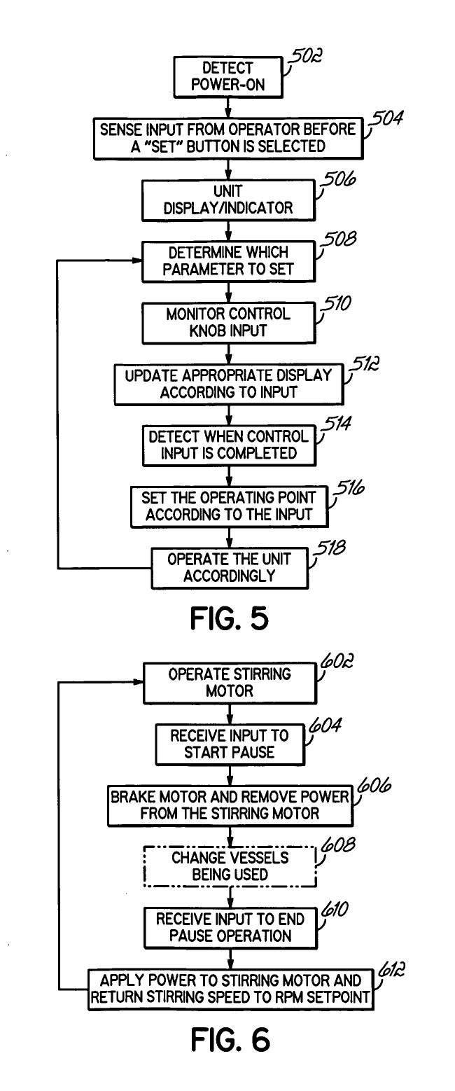

Referring to the exemplary stirring hot plate control panel 104 of FIG. 4A, the knob 414 is used to adjust temperature and stirrer speed settings according to the operation explained with reference to FIG. 5. The flowchart of FIG. 5 depicts an exemplary method for setting the operational parameters. In step 502, the control 102 detects a user operating a power switch 416 to apply power to the stirring hot plate. The control 102, in this process, will attempt to lead the user through the desired programming steps. Therefore, control 102 is looking for the user to select one of the speed or temperature set input devices or pushbuttons 408, 412; however, at step 504, the control 102 will detect the user operating any of the other controls on the control panel 104. If any other input is detected, the control 102 proceeds to step 506, which attempts to draw the user's attention to the set pushbuttons 408, 412 of the control panel 104 by flashing the respective LEDs 422, 420. Alternatively, in the absence of detecting any input from the user in step 504, the control 102 will proceed to step 506 in response to the expiration of an external timer that was set upon the stirring hot plate being turned on.

Upon the control 102 detecting, at 508, the user pressing one of the pushbuttons 408, 412, the control 102 then knows which parameter the user desires to program. Thereafter, at step 510, the control 102 monitors the control knob 414 to determine the magnitude of the setpoint being programmed by the user. For example, the control knob 414 may be attached to the shaft of a potentiometer. As the shaft is rotated, the control 102 detects the change in resistance and stores it as a setpoint magnitude or value in a memory 118. Alternatively, other input devices can be used to provide the control 102 with the desired setpoint value. For example, the control knob 414 can be connected to an optical encoder that produces a stream or series of pulses in response to rotation of the control knob 414. An optical encoder allows infinite rotation in either direction and can be designed to produce different numbers of pulses in response to control knob rotation, thereby changing the “feel” of the control knob 414.

Concurrently with detecting and storing the input from the control knob 414, the control 102 also updates, in step 512, the appropriate display 402, 404 so that the user can be informed of the operational setting which will result from the movement of the control knob 414. These displays 402, 404 can be a seven-segment display, an LCD screen, or other similar displays. Often, the temperature display 402 increments in a particular “step” size such as one-degree steps or five-degree steps as the user turns the knob up and decrements in that same step size when the user turns the knob down. Similarly, the speed display 404 may change according to a predetermined step size of the speed. Use of an optical encoder for the control knob 414 permits addition control over the displays as well. For example, the length of each pulse in the resulting string of pulses, or the number of pulses received in a set time period, is related to the speed at which the control knob 414 is being turned by the user. When the speed exceeds a certain threshold, then the step size at which the display 402, 404 is updated may be a first value and when the speed is below that threshold then the step size is a second value. For example, when a user quickly turns the control knob 414, the temperature display 402 may be incremented in steps of 25 degrees, for example, but when the user slowly turns the knob 414, then the temperature display 402 may be incremented in one-degree steps.

The control 102 detects, in step 514, when input is no longer being received via the control knob 414. For example, the control 102 may determine that the input is complete if the control knob 414 has not been moved for some time period, for example, at least two seconds or some other time period. Alternatively, if the user presses either of the set inputs 408, 412, then the control 102 determines that the current setting of the control knob 414 is the value to be used for the preset. The control 102 then stores, at step 516, the current control knob setting in the memory 118 as the temperature or speed setpoint depending on which of the temperature or speed set inputs 412, 408 was detected.

Thereafter, at step 518, the control 102 operates the heater 106 or motor 112 in accordance with the setpoint programmed by the user. The control 102 uses feedback from the temperature sensor 108, a temperature calibration algorithm and the programmed temperature setpoint to control the operation of the heater 106 in a known manner. Thus, the control 102 is able to maintain the temperature of either the plate 124 or the fluid 128 in the flask 126 or a dry bath block near the programmed temperature setpoint.

When the heater 106 is initially turned on, there is typically a warm-up period before the temperature of the plate 124 attains the desired temperature. Accordingly, the temperature being displayed within the temperature display 402 will not always be the same as the current temperature setpoint. One advantageous method of using the control panel 104 is to display the setpoint value during the time the user is inputting the setpoint and display the detected temperature of the plate 124 at other times. For example, when the temperature set switch 412 is depressed, the display 402 displays the temperature setpoint; and the LED 420 is lit to indicate to the user that the temperature setpoint is being displayed. The user can then change the temperature setpoint or simply observe the current setting. After a period of inactivity, such as for example, 3 seconds, the LED 420 is turned off by the control 102; and the display 402 reverts to displaying the detected temperature of the plate 124.

The speed set switch 408, LED 422 and display 404 operate in a manner similar to the temperature set switch 412, LED 420 and display 402 just described. Thus, upon a user entering or programming a speed setpoint, the control 102 turns on the motor 112 and adjusts its speed to maintain the stirring speed near the speed setpoint.

While the stirring hot plate is operating, the control 102 continues to monitor the control panel 104 to determine when a user wants to change an operational setpoint or perform some other function. For example, the user may desire to exchange vessels on the plate 124; and in many instances, the user will want to continue to use the stored temperature and speed setpoints with a new vessel.

As will be appreciated, the control panel 104 provides an advantage that a single control knob 414 is usable to program a plurality of setpoint values, that is, the temperature and speed setpoints. Thus, the control panel 104 provides an input device, that is, the control knob 414, which is easy for the operator to use while at the same time reducing the physical size of the control panel that would be required if two knobs 414 were used. The capability of having a single input device for programming multiple setpoints is illustrated in FIG. 4A with respect to a stirring hot plate control panel. The same principle may be applied to enter other setpoints. For example, FIGS. 4B, 4C and 4D show respective control panels 140, 142 and 144 of a stirring hot plate, a stirrer and a hot plate, respectively. Numerical references in FIGS. 4B, 4C and 4D that are the same as numerical references in FIG. 4A are used to identify components that are substantially similar to the commonly numbered components in FIG. 4A. Referring to FIG. 4B, a control panel 140 uses the control knob 414 to program a temperature setpoint, a speed setpoint and a time setpoint. The time setpoint is programmed in the same manner as described previously with respect to the temperature and speed setpoints utilizing the set pushbuttons 412, 408 of FIG. 4A. With the control panel 140 of FIG. 4B, a time set pushbutton 427 is initially depressed to advise the control 102 that a time setpoint is being programmed. Thereafter, as the user rotates the control knob 414, the cycle time is displayed in the time display 405. Thereafter, the control 102 stores the displayed time as a time setpoint in response to either a subsequent pressing of the time pushbutton 427 or the knob 414 not being rotated for some time duration.

Referring to FIG. 4C, a control panel 142 for a stirrer is illustrated in which the control knob 414 may be used to set speed and time setpoints as previously described. A hot plate control panel 144 is shown in FIG. 4D wherein the control knob 414 may be used to program both temperature and time setpoints as previously described.

To facilitate and simplify unloading of a vessel and loading a new vessel, the control panel 104 includes a pause pushbutton 406. FIG. 6 depicts a flowchart of an exemplary method executing a pause operation for the stirring hot plate. As indicated at step 602, prior to executing a pause operation, a speed setpoint has been programmed and the motor 112 is operating at a speed near the speed setpoint. Thereafter, at step 604, the control 102 receives an input or an indication that the user wants to execute a pause cycle or operation, that is, pause the operation of the stirring motor 112. In this embodiment, such a indication is received by the control 102 upon the user activating a pause input device or pushbutton 406. Visual feedback to the user may be provided by illuminating LED 424 during the pause operation.

In response to receiving the pause input, the control 102, at step 606, stops the stirrer motor 112. The control 102 can abruptly interrupt power to the motor 112, or it may brake the motor 112 as described earlier using a phase-controlled voltage. Even though the motor 112 is stopped, power to the temperature controls and other circuitry of the control 102 is not interrupted or affected by the pause operation. Therefore, operation of the heater continues in accordance with the temperature setpoint and the current speed setpoint remains stored in the memory 118.

After power to the stirring motor 112 has been interrupted, the user can, at step 608, remove the current vessel from the plate 124 and load a new vessel thereon. Once the new vessel is loaded, the user then provides an input indicating that the pause cycle is to be ended, for example, in this embodiment, the user presses the pause pushbutton 406 a second time. Upon the control 102, at step 610, receiving that user input, the control 102, at step 612, applies power to the stirrer motor 112. The control 102 then operates the motor 112 at a speed that corresponds to the speed setpoint that was effective prior to initiating the pause operation. Thus, the stirring operation is interrupted and restarted with a new vessel without requiring the user to re-enter or reprogram the speed setpoint or any other information.

The above pause operation is described with respect to a stirring hot plate; however, as will be appreciated, the same pause operation can be implemented on stirrers. Referring to FIG. 4C, a pause operation may be initiated by depressing the speed set pushbutton 408 for an extended time duration or depressing a combination of the speed set and time set pushbuttons 408, 427, respectively. In either event, the pause operation described above with respect to FIG. 6 is executed.

The control panel 104 includes other input choices for the user, all of which can be detected by the control 102. For example, a timer control 426 is included on the control panel 104 that allows the user to preset a time period for the stirring hot plate to operate. For example, the input devices or pushbuttons 426 may be used to increment or decrement preset time periods. LEDs 428 are present to indicate the current time period setting.

Another input choice for a user is the “presets” input devices or pushbuttons 418. Although the exemplary control panel 104 includes four preset pushbuttons 418, one of ordinary skill will recognize that a different number of preset pushbuttons may be used without departing from the scope of the present invention. The control 102 includes memory 118 that stores sets of temperature and speed setpoints. During operation of the stirring hot plate, upon the user pressing one of the preset pushbuttons 418, the current operating parameters, that is, the current hot plate temperature and the current stirring speed, will be automatically stored in the memory 118 in association with the one of the preset pushbuttons pressed.

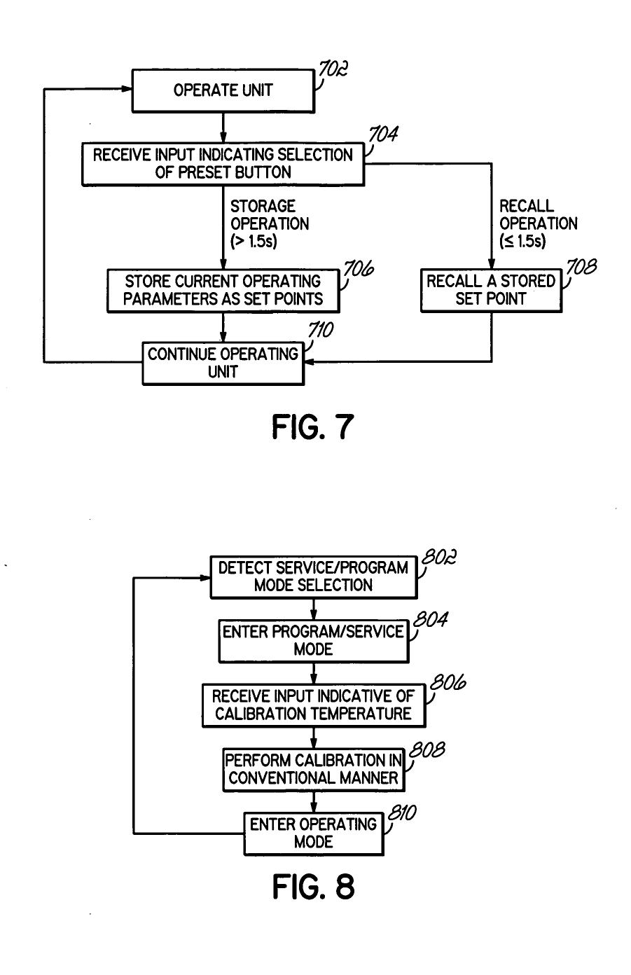

Thus, referring to FIG. 7, while the hot plate is operating as indicated at step 702, the user may select one of the preset pushbuttons 418; and, at step 704, the control 102 receives an input from the selected pushbutton. In this exemplary embodiment, the same preset pushbutton is used to input or program a set of presets as well as activate or recall the set of presets. Although a number of different methods may be used to detect which type of operation the user is selecting, one advantageous method is to detect how long the preset pushbutton 418 is depressed. For example, if the control 102, at step 706, detects that the pushbutton 418 is held down for more than 1.5 seconds, then a store operation is performed; and the control 102 stores in the memory 118 the current temperature and speed setpoints as respective temperature and speed setpoints associated with the preset pushbutton being pushed. Further, the current operation of the stirring hot plate continues without interruption.

However, if, at step 708, the control 102 detects that the preset pushbutton 418 is held down less than 1.5 seconds, then an activate or recall operation is performed. In response thereto, the control 102 retrieves temperature and speed setpoints from memory that are associated with the preset pushbutton being pressed and makes those temperature and speed setpoints the currently active setpoints. Thus, at step 710, the control 102 operates the stirring hot plate according to the temperature and speed setpoints associated with the preset pushbutton that was pressed.

As will be appreciated, while the above presets pushbuttons 418 are described with respect to the stirring hot plate control panel 104 of FIG. 4A, they can also be used with the stirring hot plate control panel 142 of FIG. 4B, the stirrer control panel 142 of FIG. 4C and the hot plate control panel 144 of FIG. 4D.

As described earlier, a temperature control system for a hot plate and stirring hot plate includes the temperature sensor 108, which is part of a temperature measurement system, that the control 102 uses to control the heater 106. One of ordinary skill will recognize that there are numerous implementations of such a temperature control system, and the present invention is not limited to a specific control method or algorithm. Generally, the temperature measurement system is calibrated to a factory determined calibration temperature during manufacture. Therefore, with temperature setpoints at or near the calibration temperature, the sensor 108 and the feedback loop operate in an expected manner. However, as a temperature setpoint varies from the calibration temperature by a greater and greater temperature differential, the behavior of the system may be prone to temperature error. To address that problem, embodiments of the present invention permit the user to calibrate the temperature measuring system of the control 102 to a user-defined calibration temperature that is near the temperatures at which the hot plate will be operated. For example, if use of the hot plate is represented by a temperature setpoint of 250 degrees C., with the present invention, the user is able to calibrate the system about a calibration temperature of 250 degrees C. Further, the embodiments described herein permit a user to calibrate the system to a plurality of calibration temperatures of the user's choice.

In one embodiment of the present invention, the stirring hot plate has two different modes of operation—a standard operating mode, and a service or program mode. One exemplary way to enter the service mode is for the control 102 to detect that upon the power pushbutton 416 being initially depressed, it is held depressed for some period of time, for example, more than 3 seconds. Upon detecting this power-on condition, the control 102 may enter the service mode rather than the standard operating mode. As an alternative, the control 102 may also detect an activation of a combination of pushbuttons on the control panel 104. For example, if the user simultaneously pressed both the temperature set 412 and the speed set 408 pushbuttons, then the service mode may be entered. FIG. 8 depicts a flowchart of an exemplary method for choosing a calibration temperature for a hot plate or a stirring hot plate.

At step 802, the control 102 detects a service mode selection by the user, for example, by detecting, as described above, an extended depression of the power on pushbutton or a depression of a combination of pushbuttons. The control 102, at step 804, then enters the service mode. In the service mode, some of the input devices and display elements on the control panel 104 may have different functions than in the standard operating mode. For example, one or more of the LEDs 428, 422, 424, 420 may light or blink to indicate that the service mode is active. The displays 402 and 404 may display different messages to assist a user in performing different functions while in the service mode.

Ultimately, the control 102 receives, at step 806, an input from the control panel 104 indicating that the user wants to program a calibration temperature. For example, the heat display 402 may initially be all zeroes or blank upon entering the service mode. However, as the user turns the control knob 414, the control 102 updates the display 402 to reflect a desired calibration temperature. Thus, in a manner similar to the process for selecting a temperature setpoint, the user is able to select a calibration temperature. Again, in response to the user pressing the temperature set pushbutton 412 or not moving the knob 414, the control 102 stores the current value in the temperature display 402 as the calibration temperature. Further, in a manner similar to the selection of preset sets of temperature and speed setpoints in the standard mode, the presets pushbuttons 418 can be used to select multiple calibration temperatures in the service mode.

Thereafter, at step 808, the user then provides a further input to initiate one or more calibration procedures using the user selected calibration temperatures in a conventional manner. The present invention does not alter the specific method by which a stirring hot plate is calibrated; thus, embodiments of the present invention contemplate using any conventional method, mechanism or procedure for calibrating stirring hot plates. Instead, embodiments of the present invention permit the user to select the calibration temperature at which the stirring hot plate is calibrated instead of requiring that the hot plate be calibrated at a factory pre-set temperature.

One exemplary calibration method is to calibrate the system to the temperature of the fluid 128 in the vessel 126. This calibration process uses an external temperature probe 120 and precision or calibrated temperature sensor 116 that are placed in the fluid 128. Upon entering a calibration cycle, the control 102 sets the calibration temperature as a temperature setpoint and operates the heater 106 as previously described. The external probe temperature can be displayed within the display 402. The calibration of the temperature measuring system of the control 102 to the calibration temperature requires a difference between the temperatures measured by the external probe 120 and the calibrated temperature sensor 116. That difference can be entered into the control 102 by several different procedures, and the present invention contemplates all such procedures. For example, the user can operate the control knob 414 to enter the temperature measured from the precision temperature sensor 116 such that it is reflected in the display 402. The control is connected to the external probe via connector 410 on the control panel 414 and thus, can detect the temperature measured by the external probe. Given the two temperature values, the control 102 can calculate an offset, or correction factor, specifically at the user-selected calibration temperature after determining the difference between the two temperature values. In an alternative embodiment, the temperature detected by the external probe can be displayed in the temperature display 402, and the user can determine the difference between the temperatures of the external temperature probe 120 and the calibrated temperature sensor 116. The difference can be entered into the control 102 via the knob 414, and the control 102 can execute a known calibration process as previously described.

Another exemplary calibration method is to calibrate the system to the temperature of the plate 124. This calibration process uses the temperature sensor 108 that is detecting plate temperature and the calibrated temperature sensor 116 that is also measuring the temperature of the plate 124. Upon entering a calibration cycle, the control 102 sets the calibration temperature as a temperature setpoint and operates the heater 106 as previously described. The calibration is performed as described above given the detected temperatures of the temperature sensor 108 and the calibrated temperature sensor 116. The temperature from the sensor 108 can be displayed on the temperature display 402; and as described above, the user can enter the temperature from the calibrated temperature sensor 116 or a difference between the temperature sensor 108 and the calibrated temperature sensor 116.

Thus, a user is not limited to a factory set calibration temperature that may or may not be particularly useful; but, instead, may select one or more calibration temperatures at which the control temperature measurement system can be calibrated. Once the calibration cycle is complete, at step 810, the service mode may be exited by the user again depressing a pushbutton, for example, the pause pushbutton; and the control 102 then enters the standard operating mode.

As will be appreciated, while the above capability of programming a calibration temperature is described with respect to the stirring hot plate control panel 104 of FIG. 4A, it can also be used with the stirring hot plate control panel 142 of FIG. 4B and the hot plate control panel 144 of FIG. 4D.

While the invention has been illustrated by the description of one embodiment and while the embodiment has been described in considerable detail, there is no intention to restrict nor in any way limit the scope of the appended claims to such detail. Additional advantages and modifications will readily appear to those who are skilled in the art.

For example, the control panel 104 may include additional display features that warn the user of the “hot” condition of the stirring hot plate platform, such as described in the previously mentioned and incorporated provisional patent applications. In conjunction with such displays, the control 102 may include additional monitoring algorithms and circuitry to determine how to utilize such additional displays. As another alternative, some of the features described herein may be useful with a generic stirrer rather than a stirring hot plate. For example, the “pause” feature and the “presets” feature are as applicable to a stirrer as to a stirring hot plate.

Therefore, the invention in its broadest aspects is not limited to the specific details shown and described. Consequently, departures may be made from the details described herein without departing from the spirit and scope of the claims which follow.

1. A magnetic stirrer for stirring a liquid in a vessel comprising:
a plate having a generally horizontal upper surface adapted to support a vessel containing a liquid to be stirred;
a magnetic stir bar adapted to be placed in the vessel;
a motor mounted below the plate and operative to provide a magnetic field coupling with the stir bar and causing the stir bar to stir the liquid in the vessel; and
a programmable control operatively connected to the motor, the control comprising
a memory for storing a speed setpoint determined by a user, the control being operable to rotate the stirring bar at a speed substantially equal to the speed setpoint, and
a first input device operable to cause the control to initiate a pause operation by stopping the motor and hence, a stirring bar rotation, while maintaining the speed setpoint within the control.

2. The magnetic stirrer of claim 1 wherein the first input device is operable to cause the control to end the pause operation by resuming operation of the motor and hence, the stirring bar rotation at the speed setpoint.

3. The magnetic stirrer of claim 1 wherein the first input device is operable to cause the control to de-energize the motor.

4. A stirring hot plate for heating and stirring a liquid in a vessel comprising:
a plate having a generally horizontal upper surface adapted to support a vessel containing a liquid to be heated and stirred;
a heating element adapted to be in a heat transfer relation to the vessel supported on the plate;
a magnetic stir bar adapted to be placed in the vessel;
a motor mounted below the plate and operative to provide a magnetic field coupling with the stir bar causing the stir bar to stir the liquid in the vessel;
a programmable control operatively connected to the motor and the heating element, the control comprising
a memory for storing a temperature setpoint and a speed setpoint determined by a user, the control being operable to cause the stirring bar to rotate at a speed substantially equal to the speed setpoint, and
a first input device operable to cause the control to initiate a pause operation by stopping the motor and hence, stirring bar rotation, while maintaining the speed setpoint within the control.

5. The stirring hot plate of claim 4 wherein the first input device is operable to cause the control to end the pause operation by resuming operation of the motor and hence, the stirring bar rotation at the speed setpoint.

6. The stirring hot plate of claim 4 wherein the first input device is operable to cause the control to de-energize the motor.

7. A magnetic stirrer stirring a liquid in a vessel comprising:
a plate having a generally horizontal upper surface adapted to support a vessel containing a liquid to be heated and stirred;
a magnetic stir bar adapted to be placed in the vessel;
a motor mounted below the plate and operative to provide a magnetic field coupling with the stir bar causing the stir bar to stir the liquid in the vessel;
a programmable control operatively connected to the motor, the control comprising a memory for storing a plurality of setpoints determined by a user, and
one input device operable to provide quantitative values for respective ones of the plurality of setpoints.

8. The magnetic stirrer of claim 7 wherein the memory in the control stores a speed setpoint and/or a time duration and the one input device is operable to provide a quantitative value for each of the speed setpoint and the time duration.

9. The stirrer of claim 8 wherein the one input device is further operable to provide a quantitative value for the time duration.

10. A stirring hot plate for heating and stirring a liquid in a vessel comprising:
a plate having a generally horizontal upper surface adapted to support a vessel containing a liquid to be heated and stirred;
a heating element adapted to be in a heat transfer relation to the vessel supported on the plate;
a magnetic stir bar adapted to be placed in the vessel;
a motor mounted below the plate and operative to provide a magnetic field coupling with the stir bar causing the stir bar to stir the liquid in the vessel;
a programmable control operatively connected to the heating element and the motor, the control comprising
a memory for storing a plurality of setpoints determined by a user, and
one input device operable to provide quantitative values for respective ones of the plurality of setpoints.

11. The stirring hot plate of claim 10 wherein the memory in the control stores a temperature setpoint, a speed setpoint and a time duration and the one input device is operable to provide a quantitative value for each of the temperature setpoint and the speed setpoint.

12. The stirring hot plate of claim 11 wherein the one input device is further operable to provide a quantitative value for the time duration.

13. A hot plate for heating an object comprising:
a plate having a generally horizontal upper surface adapted to support the object to be heated;
a heating element adapted to be in a heat transfer relationship with the object;
a programmable control operatively connected to the heating element, the control comprising
a memory for storing a plurality of setpoints determined by a user, and
one input device operable to provide quantitative values for respective ones of the plurality of setpoints.

14. The hot plate of claim 13 wherein the memory in the control stores a temperature setpoint and/or a time duration and the one input device is operable to provide quantitative values for the temperature setpoint and the time duration.

15. A stirring hot plate for heating and stirring a liquid in a vessel comprising:
a plate having a generally horizontal upper surface adapted to support a vessel containing a liquid to be heated and stirred;
a heating element adapted to be in a heat transfer relationship to the vessel supported on the plate;
a temperature sensor adapted to be in a heat transfer relationship to the vessel supported on the plate;
a magnetic stir bar adapted to be placed in the vessel;
a motor mounted below the plate and operative to provide a magnetic field coupling with the stir bar causing the stir bar to stir the liquid in the vessel;
a control operatively connected to the motor, the heating element and the temperature sensor, the control comprising
a memory for storing a calibration temperature determined by a user,
a temperature measurement system including the temperature sensor,
a first input device operable to provide a calibration temperature and a calibration value, the calibration value being determined from a temperature measurement more accurate than a temperature detected by the temperature sensor, and the control being operable to use the calibration value to calibrate the temperature measurement system to the calibration temperature.

16. A hot plate for heating an object comprising:
a plate having a generally horizontal upper surface adapted to support the object to be heated;
a heating element adapted to be in a heat transfer relationship with the object;
a temperature sensor adapted to be in a heat transfer relationship with the object;
a control operatively connected to the heating element and the temperature sensor, the control comprising
a memory for storing a calibration temperature determined by a user,
a temperature measurement system including the temperature sensor,
a first input device operable to provide a calibration temperature and a calibration value, the calibration value being determined from a temperature measurement more accurate than a temperature detected by the temperature sensor, and the control being operable to use the calibration value to calibrate the temperature measurement system to the calibration temperature.
